(19) United States
(12) Patent Application Publication
(10) Pub. No.: US 2003/0217280 A1
(43) Pub. Date: Nov. 20, 2003

(54) Software watermarking for anti-tamper protection

(76) Inventors: Thomas S. Keaton, Fremont, CA (US); Larry Yelowitz, Sunnyvale, CA (US)

Correspondence Address: Keith D. Nelson, Lockheed Martin Corporation, Building 220, Mail Stop A08, P. O. Box 49041, San Jose, CA, 95161-9041, US

(21) Appl. No.: 10/150,375

(22) Filed: May 17, 2002

(51) Int. Cl. G06F 12/14

(52) U.S. Cl. 713/193

(57) ABSTRACT

Systems, methods and software that provide for watermarked executable software. A software program is processed to create a watermarked software program comprising a fingerprint of a system on which it is to run and its clock, loadable executables that each contain an embedded encryption/decryption algorithm, and an execution instance. A secure ID device contains a clock that updates initialization code used by the watermarked software program. A storage medium contains the watermarked software program from which it is loaded into executable memory of a system on which it executes. A processor of the system is used to initialize the watermarked software program using predetermined initialization parameters and the initialization code from the secure ID device and execute the watermarked software program. The watermarked software program executes an executable in a first software module, which executable comprises the embedded encryption/decryption algorithm and a first encryption key. An integrity check is performed prior to communicating with a second software module, such as by summing or hashing a binary representation of the executable with the first encryption key. Data to be communicated to the second software module is encrypted using the embedded encryption/decryption algorithm and the first encryption key. The encrypted data is transmitted from the first software module to the second software module. The encrypted data is decrypted at the second software module using an embedded encryption/decryption algorithm and a corresponding second encryption key.

### BACKGROUND

The present invention relates generally to software watermarking, and more particularly, to software watermarking that provides anti-tamper protection.

Exemplary prior art software relating to watermarking may be found by reviewing the Intel® Renewable Authentication Agent System 1.2, Developer's Guide, that is available on the Internet at http://www.intel.com/support/security/rssg/intro.htm. Traditional watermarking, such as the Intel software, for example, protects intellectual property against copyright violation.

There is a large body of technology relating to software watermarking. This technology is designed to apply copyright protection to digital forms of music, images, or other such material. The approach in this traditional technology is to embed a watermark in a digital object which is subject to copyright protection. Then, if an unauthorized copy of the digital object appears (and the copyright owner finds out about it), the owner can assert his claim via litigation, after the violation has occurred.

Tactical warfare systems and other systems that are critical to the support of tactical functions are vulnerable to spoofing. Spoofing may take place in two different ways. Software that is critical to the function of the system may be copied or pirated and a clone system created that impersonates the system supporting tactical functions. This cloned system can be used to deceive other users of the system. A second form of spoofing is to insert Trojan Horses into the tactical system that work with the original system and that may be variants of original functions within the system.

It is very difficult to prevent cloning of the software in these systems given the reverse engineering technology that exists. Once cloned, a system's functionality can be assumed by knowing or obtaining certain key parameters such as passwords, for example. It is even more difficult to prevent a Trojan Horse from being absorbed into a system.

What is required is the capability to make both of the above spoofing techniques extremely difficult so that these systems are economically tamper resistant. There is no currently-available technique that is provably tamper resistant. To make a system provably tamper resistant, as well as making a system provably secure, is very expensive.

It is therefore an objective of the present invention to provide for systems, methods and software that implement watermarking to provide anti-tamper protection.

### SUMMARY OF THE INVENTION

To meet the above and other objectives, the present invention comprises systems, methods and software that provide for watermarked executable software. The present invention processes a software program to create a watermarked software program comprising a fingerprint of a system on which it is to run and its clock, loadable executables that each contain an embedded encryption/decryption algorithm, and an execution instance.

A secure ID device contains a clock that updates initialization code used by the watermarked software program. A storage medium contains the watermarked software program from which it is loaded into executable memory of a system on which it executes. A processor of the system is used to initialize the watermarked software program using predetermined initialization parameters and the initialization code from the secure ID device and execute the watermarked software program.

The watermarked software program executes an executable in a first software module, which executable comprises the embedded encryption/decryption algorithm and a first encryption key. An integrity check is performed prior to communicating with a second software module, such as by summing a binary representation of the executable with the first encryption key. Alternatively, a hashing function or other integrity algorithm may be performed on a binary representation of the executable with the first encryption key.

Data to be communicated to the second software module is encrypted using the embedded encryption/decryption algorithm and the first encryption key. The encrypted data is transmitted from the first software module to the second software module. The encrypted data is decrypted at the second software module using an embedded encryption/decryption algorithm and a corresponding second encryption key.

The present invention thus provides for systems, methods and software that protect specified software applications from tampering, rehosting, and piracy. Tamper protection means that the software will cease executing within a short time of the instant that a modified module attempts to communicate with a peer level module.

Rehosting protection means that the software application will only execute on a pre-specified host platform. An attacker who steals the software (either from an external device or from a snapshot of the software's binary code during execution on its legitimate host platform) will be unable to cause the application to execute on a nonauthorized platform.

Piracy protection means that an attacker who steals the software will have a much more difficult task of reverse engineering its logic than is normally the case. This is due to the use of obfuscating techniques that convert the software to a new incarnation with the same functionality. The new incarnation, however, is far more complex to reverse engineer.

The watermarking approach implemented by the present invention makes the above-discussed spoofing techniques very difficult and expensive. The present software watermarking prevents unauthorized use and prevents tampering with installed system software.

In contrast to conventional watermarking approaches that provide for after the fact protection, the present invention provides protection against tampering, rehosting, and piracy, and achieves protection against security violations in real time. The present invention combines three types of protection into a single system, and runs on a given platform without making any architectural assumptions.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 is a flow diagram that illustrates an exemplary software watermarking process in accordance with the principles of the present invention;

FIG. 2 illustrates installation of a program having software watermarking;

FIG. 3 illustrates operation of an executable embodiment of the present invention; and

FIG. 4 is a flow diagram that illustrates an exemplary software watermarking method in accordance with the principles of the present invention.

### DETAILED DESCRIPTION

The following detailed description illustrates the novelty in of the present software watermarking approach versus that of the above-mentioned Intel approach. The present software watermarking approach has as its basis security protection, rather than after-the-fact litigation of copyright violations. The Intel approach relies on a traditional client/server architecture. The present technique works in any environment, including traditional client/server architectures, but does not rely on the presence of a server.

The Intel approach mentioned in the Background section assumes that an attacker that has infiltrated a client's machine will be unable to prevent an authentication agent from properly carrying out it's task of retrieving a processing serial number of a client host, computing a hash of this value, and sending the value back to the server. This is a risky assumption, since a clever attacker that has infiltrated a client host can subvert the authentication agent into sending an incorrect value back to the server. Thus the server will incorrectly believe that the client host is a different one than it actually is.

In contrast, the present invention does not rely on any assumptions that a given piece of software (such as an authentication agent) will execute correctly. Instead, all communications among software modules are encrypted and authenticated, preventing an attacker from sending false information back to a server or any other location.

In the present invention, a new secret key is established after each communication between any two software modules, and the new secret key is used for encryption and authentication. Thus, an attacker who manages to learn the value of a given key (a highly complex task), will be unable to use the key beyond a single communication between two software modules.

The present invention combines three types of protection (tamper, rehosting, piracy) into a single system, and runs on a given platform (either client or server) without making any assumptions about the overall architecture of the system. In terms of tamper protection, modifications to a module include all unauthorized changes, such as attachments of viruses or other generic types of malevolent software, as well as more targeted and specific changes that attempt to exploit a particular software module.

The software watermarking technique is flexible enough to trade off performance of a number of peer level software modules (derived from the original application software) with overall performance requirements. The more peer level software modules that are present, the more frequently there will be communication between peer software modules, and thus the sooner an application will stop after a modified software module is invoked. On the other hand, a larger number of peer level software modules implies that the overall application will experience some performance degradation.

The present software watermarking systems, methods and software provide for executable software that prevents tampering. The software watermarking systems, methods and software prevent piracy of code and spoofing of systems, e.g., that might occur if an attacker were to insert malicious code into executables. The software watermarking systems, methods and software is designed to protect software against a number of specific threats. The present invention protects against copying of the software from its original delivery medium and pirating or using it without permission. The present invention protects against copying of the software from a random access device or medium used by a processor. The present invention also protects against snapshooting and copying the software while it is in memory on an executing processor.

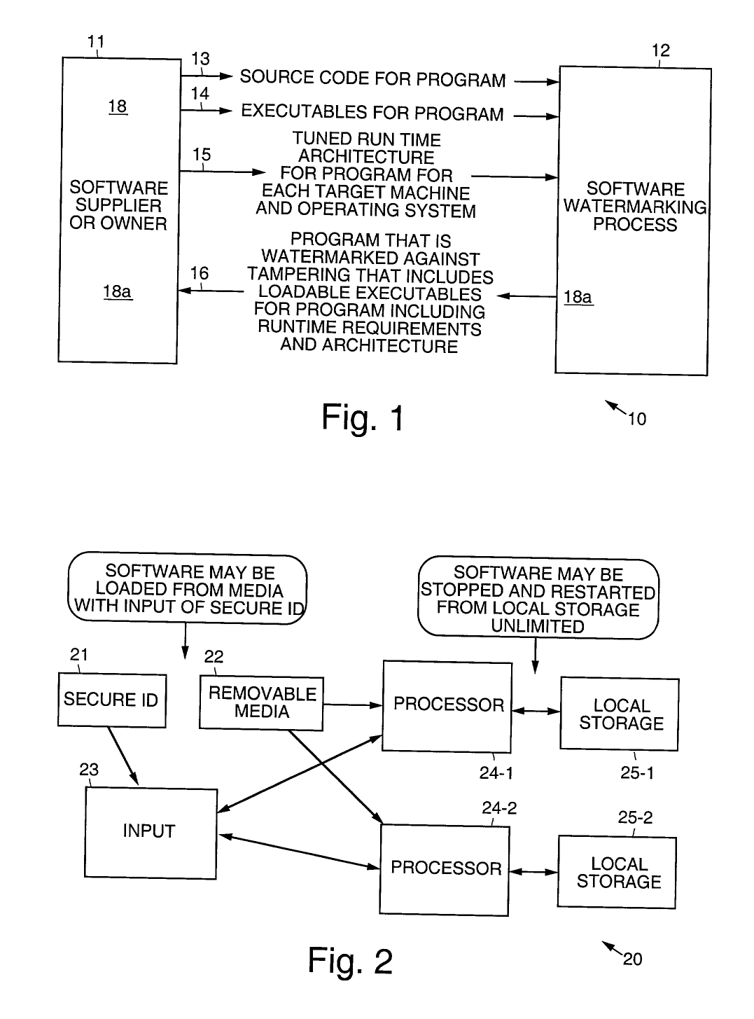

Referring now to FIG. 1, it is a flow diagram that illustrates an exemplary software watermarking process 10 implemented in accordance with the principles of the present invention. As depicted in FIG. 1, a software supplier 11 or owner 11, provides 13 source code for an application program 18 (or software application 18) that is to be watermarked to the software watermarking process 10. The software supplier 11 or owner 11, provides 14 executables for the application program 18 as they have been created for loading onto a target system. The software supplier 11 or owner 11, also provides 15 parameters for tuning a runtime system including optimized runtime processes or tasking architecture for each target operating system on which the application program 18 is to be run.

A watermarked version of the application program (a watermarked program 18a) is created and returned 16 to the software supplier or owner 11 that includes loadable executables that are consistent with the runtime environment and tuning delivered to the watermarking process 10, initialization parameters and codes that are used to initialize the watermarked program 18a, and initialization procedures for initializing the watermarked program 18a.

Details of how an exemplary software program 18 is watermarked is discussed below. The original application program 18 (or software application 18) that is to be watermarked includes a set of one or more processes. This original process structure is made more complex using the present invention, wherein each of the original processes is decomposed into one or more sub-processes. This approach of adding complexity may be achieved using manual methods. It is the sub-process software architecture that is the starting point for the automated methods implemented by the present invention. Each sub-process is provided with a set of encryption keys (discussed below). This allows the sub-processes to communicate with each other via standard encryption and decryption techniques. The sub-processes send each other key updates after each message, as described herein.

Referring to FIG. 2, it illustrates installation of a watermarked program 18a having software watermarking in accordance with the present invention. As is depicted in FIG. 2, the watermarked program 18a is loaded onto a disk or storage medium 22 from which it is always loaded into executable memory of a processor 24-1, 24-2 from initialization forward in time.

The watermarked software program 18a is loaded from a medium 22 provided by the software watermarking process 10. A Secure ID card 21 is provided which contains data that is input 23 to the watermarked software program 18a upon execution. The Secure ID card 21 includes a clock that updates initialization code of the watermarked program 18a on a regular basis, such as every minute, for example. When the code is initialized, the watermarked program 18a creates a fingerprint of a target system (processor 24-1, 24-2) on which it is to run based upon the system (hardware) 24-1, 242 and its respective clock. The hardware clocks of the processors 24-1, 24-2 (or target systems) must operate within a specified accuracy over time or the watermarked software program 18a will stop running if they drift too far. Also included in the hardware fingerprint is an execution instance, which will be discussed further below.

Once the watermarked software program 18a is downloaded onto a storage device 25-1, 25-2 of a target system or processor 24-1, 24-2, it is initialized using certain initialization parameters and the code from the Secure ID card 21. The watermarked software program 18a then executes. The watermarked software program 18a continues to execute over time.

With regard to the initialization parameters and code contained in the Secure ID card, 21, it generates a set of random numbers for each process, corresponding to the encryption keys that the given process initially uses for sending encrypted messages to other processes. The method by which the Secure ID card 21 provides this set of keys to each process is indirect: The Secure ID card 21 loads the value of the random numbers into process memory in a “scattered” fashion, rather than as a contiguous sequence of bits. The Secure ID card 21 also provides the process a code or tag by which the process can access the key to use it as a coherent value in performing encryption and decryption.

However, when the watermarked software program 18a is shut down, it must be restarted using the initialization code from the Secure ID card 21. The watermarked software program 18a cannot be restarted from its storage device 25-1, 25-2 without reinitializing using the Secure ID card 21. It is not necessary to re-enter the initialization parameters each time the watermarked software program 18a is restarted, since the software program 18a will have created a fingerprint of the hardware, or processors 24-1, 24-2, on which it is to run. The execution instance is checked each time, which requires that it be reinitialized using the initialization process.

With the approach implemented by the present invention, an attacker who wishes to pirate the watermarked software program 18a is required to have (1) the original media from which the watermarked software program 18a is downloaded, (2) the Secure ID card 21, and (3) the initialization parameters that are based upon the hardware platform on which the watermarked software program 18a runs (which is provided to the watermarking process 10 when the original software program 18 is delivered watermarking).

The initialization parameters are provided for each machine on which the watermarked software program 18a is to run. The hardware fingerprint calculated by the watermarked software program 18a is based upon parameters established for the target machine (processors 24-1, 24-2) during the watermarking process 10. The parameters supplied with the watermarked software program 18a are determined from characteristics of the target machine (processors 24-1, 24-2). These characteristics are kept secret from the watermarking process 10 and how the algorithm in the watermarked software program 18a handles them is changed for each instance of watermarked software program 18a.

If the storage media 25-1, 25-2 associated with a target machine (processors 241, 24-2) is stolen and attached to another machine, then it will not run. The watermarked software program 18a uses a fingerprint that calculated based upon the target machine (processors 24-1, 24-2) when it is initialized.

If reverse engineering tools are used to snapshot memory and attempts are made to reverse engineer the watermarked software program 18a, this becomes extremely difficult. Communication between processes and the division of code into processes is such that without knowledge of how the hardware fingerprint is calculated and how tags are embedded into the watermarked software program 18a, it will be extremely difficult to recreate the watermarked software program 18a. This is addressed below.

Any tampering with the watermarked software program 18a will cause it to stop execution. The watermarked software program 18a is partitioned into separate processes over and above its original process structure to ensure that no one process can run without the others.

There is a slight performance penalty due to the watermarking process 10. However, the watermarking process 10 optimizes the overall performance of the watermarked software program 18a with watermarking included. The functionality of the executable watermarked software program 18a is not altered. It should be noted that all watermarking using conventional techniques slightly alters the original material.

The underlying technical concept implemented by the present invention involves two basic principles. The first is secure communications between entities (software modules) based upon encryption of information with symmetrical key pairs. The second is integrity checking of code.

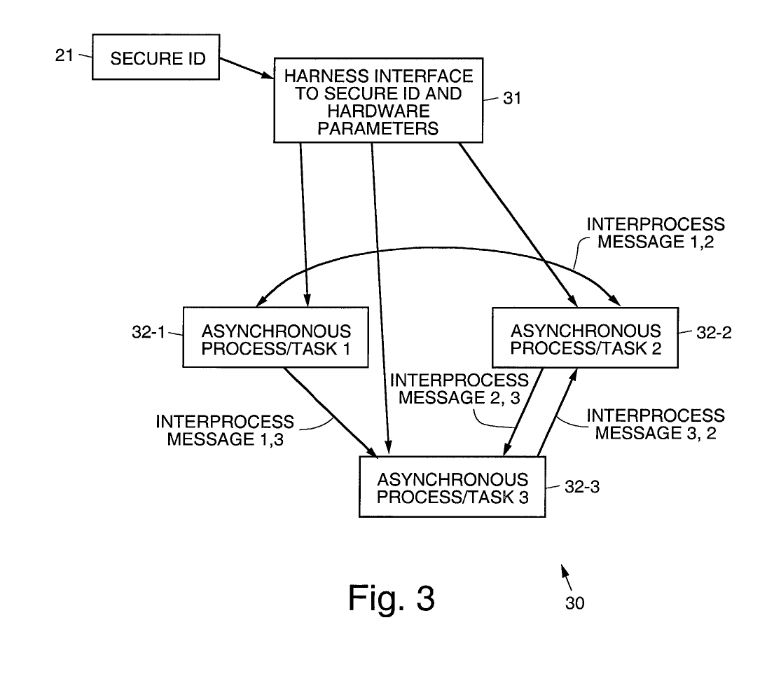

Referring to FIG. 3, it illustrates operation of an executable embodiment of the present invention. As is shown in FIG. 3, an executable watermarked software program 18a has undergone a compile and linking process, and an executable run-time architecture has been established such that executables that operate as asynchronous tasks, processes, or threads 32-1, 32-2, 32-3, under a multitasking operating system, for example, have been determined and fixed. Processes 32-1, 32-2, 32-3 may be swapped out and context switches may take place at the discretion of the operating system.

The executables within each task are laced with tags (keys) that are summed with a binary representation of the executable when an integrity check is performed. In a preferred embodiment, the integrity check performed by each executable provides it with a pair portion that is part of its asynchronous exchange of interprocess messages with any of the other processes 32-1, 32-2, 32-3. Each of the other processes 32-1, 32-2, 323 has a counterpart to that tag (key) for its communication with the corresponding process 32-1, 32-2, 32-3. Exchange of data between these processes 32-1, 32-2, 32-3 is encrypted with this tag (key). Each executable has an encryption algorithm embedded within it that is used with the tag (key) upon the exchange of inter-process messages. Each executable is provided a set of tags (keys) upon its initialization by harness software 31 which is integral to the watermarked software program 18a. The harness software 31 uses the initial parameters provided to it that are tied to the hardware platform (processor 24-1, 24-2).

Each time an executable exchanges data with a peer executable, it calculates a new key that they will both use on their next exchange of data regardless of which direction the exchange takes place. This is generally analogous to an exchange of Temporary Mobile Station Identities (TMSI) in Global System for Mobile Communications (GSM) cellular communications. If a spoofing process attempts to communicate with a watermarked software program 18a it will not have the changed keys that were based upon the last transaction. Likewise, if software is inserted into the watermarked software program 18a, it is unlikely that it can be constructed with the correct communication key. An attacker will have to listen to every communication with all of the other processes to get all of the key pairs correct.

Each time the executables are initialized, they exchange with each of the other executables, and in accordance with a set pattern, a value that is embedded into their code as one of the tags that is summed when they perform an integrity check to calculate their key pairs. The next time the system (processor 24-1, 24-2) is initialized from storage, it goes through this pattern where a new value is calculated. The first value calculated when the system (processor 24-1, 24-2) is first initialized is based upon the hardware fingerprinting value that is determined from the machine (processor 24-1, 24-2) and which is based upon the parameters that were created when the original software 18 undergoes its watermarking process 10.

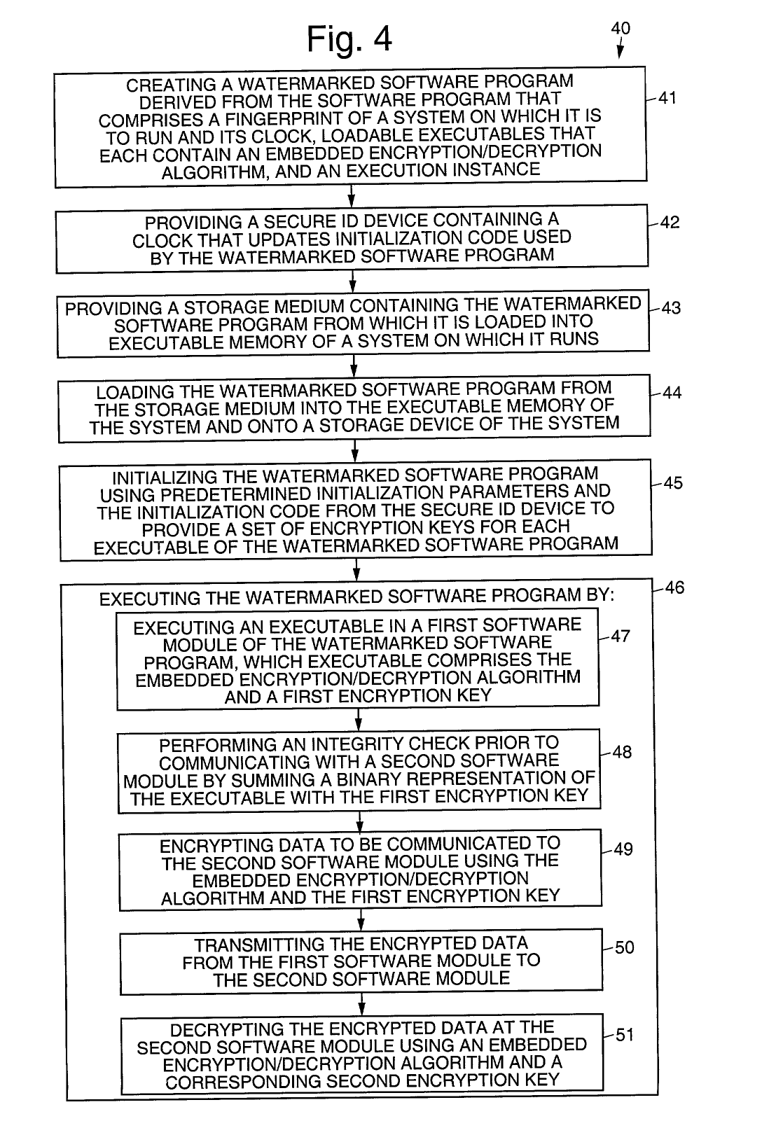

For the purposes of completeness, FIG. 4 is a flow diagram that illustrates an exemplary software watermarking method 40 in accordance with the principles of the present invention. The exemplary software watermarking method 40 comprises the following steps.

A watermarked software program 18a is created 41 that is derived from the software program 18 that comprises a fingerprint of a system on which it is to run and its clock, loadable executables that each contain an embedded encryption/decryption algorithm, and an execution instance.

A secure ID device 21 containing a clock is provided 42 that updates initialization code used by the watermarked software program 18a. A storage medium containing the watermarked software program 18a is provided 43 from which it is loaded into executable memory of a system on which it runs. The watermarked software program 18a is loaded 44 from the storage medium into the executable memory of the system and onto a storage device of the system. The watermarked software program 18a is initialized 45 using predetermined initialization parameters and the initialization code from the secure ID device to provide a set of encryption keys for each executable of the watermarked software program 18a.

The watermarked software program 18a is executed 46 in the following manner. An executable in a first software module of the watermarked software program 18a is executed 47, which executable comprises the embedded encryption/decryption algorithm and a first encryption key. An integrity check is performed 48 prior to communicating with a second software module, such as by summing a binary representation of the executable with the first encryption key. Alternatively, a hashing function or other integrity algorithm may be performed 48 on a binary representation of the executable with the first encryption key. Data to be communicated to the second software module is encrypted 49 using the embedded encryption/decryption algorithm and the first encryption key. The encrypted data is transmitted 50 from the first software module to the second software module. The encrypted data is decrypted 51 at the second software module using an embedded encryption/decryption algorithm and a corresponding second encryption key.

Thus, systems, methods and software that protect specified software applications from tampering, rehosting, and piracy have been disclosed. It is to be understood that the described embodiments are merely illustrative of some of the many specific embodiments which represent applications of the principles of the present invention. Clearly, numerous and other arrangements can be readily devised by those skilled in the art without departing from the scope of the invention.

What is claimed is:

1. A system that protects a software program from tampering, rehosting, and piracy, comprising:
a watermarking system that processes the software program to create a watermarked software program comprising a fingerprint of a system on which it is to run and its clock, loadable executables that each contain an embedded encryption/decryption algorithm, and an execution instance;
a secure ID device containing a clock that updates initialization code used by the watermarked software program;
a storage medium containing the watermarked software program from which it is loaded into executable memory of a system on which it runs;
a storage device and an executable memory for storing the watermarked software program; and
a processor for initializing the watermarked software program using predetermined initialization parameters and the initialization code from the secure ID device and for executing the watermarked software program by:
executing an executable in a first software module of the watermarked software program, which executable comprises the embedded encryption/decryption algorithm and a first encryption key;
performing an integrity check prior to communicating with a second software module;
encrypting data to be communicated to the second software module using the embedded encryption/decryption algorithm and the first encryption key;
transmitting the encrypted data from the first software module to the second software module;
decrypting the encrypted data at the second software module using an embedded encryption/decryption algorithm and a corresponding second encryption key.

2. The system recited in claim 1 wherein the processor performes the integrity check by summing a binary representation of the executable with the first encryption key.

3. The system recited in claim 1 wherein the processor performes the integrity check by performing a hashing function on a binary representation of the executable with the first encryption key.

4. A method that protects a software program from tampering, rehosting, and piracy, comprising the steps of:
creating a watermarked software program derived from the software program that comprises a fingerprint of a system on which it is to run and its clock, loadable executables that each contain an embedded encryption/decryption algorithm, and an execution instance;
providing a secure ID device containing a clock that updates initialization code used by the watermarked software program;
providing a storage medium containing the watermarked software program from which it is loaded into executable memory of a system on which it runs;
loading the watermarked software program from the storage medium into the executable memory of the system and onto a storage device of the system;
initializing the watermarked software program using predetermined initialization parameters and the initialization code from the secure ID device to provide a set of encryption keys for each executable of the watermarked software program; and
executing the watermarked software program by:
executing an executable in a first software module of the watermarked software program, which executable comprises the embedded encryption/decryption algorithm and a first encryption key;
performing an integrity check prior to communicating with a second software module;
encrypting data to be communicated to the second software module using the embedded encryption/decryption algorithm and the first encryption key;
transmitting the encrypted data from the first software module to the second software module; and
decrypting the encrypted data at the second software module using an embedded encryption/decryption algorithm and a corresponding second encryption key.

5. The method recited in claim 4 wherein the watermarked software program is created by processing source code for the software program, executables for the software program that relate to a specific system on which the watermarked software program is to operate, parameters for tuning a runtime system including optimized runtime processes or tasking architecture for an operating system of the specific system on which the watermarked software program is to operate.

6. The method recited in claim 4 wherein the first encryption key is calculated when the watermarked software program is initialized and is based upon the hardware fingerprinting value and the parameters that were created when the original software is watermarked.

7. The method recited in claim 4 wherein each time an executable exchanges data with a peer executable, it calculates a new encryption key that they both use on their next exchange of data regardless of which direction the data exchange takes place.

8. The method recited in claim 4 wherein the step of performing the integrity check comprises summing a binary representation of the executable with the first encryption key.

9. The method recited in claim 4 wherein the step of performing the integrity check comprises performing a hashing function on a binary representation of the executable with the first encryption key.

10. Software that protects a software program from tampering, rehosting, and piracy, comprising:
code segments comprising a watermarked software program derived from the software program that comprise a fingerprint of a system on which it is to run and its clock, loadable executables that each contain an embedded encryption/decryption algorithm, and an execution instance;
a code segment that executes an executable in a first software module of the watermarked software program, which executable comprises the embedded encryption/decryption algorithm and a first encryption key;
a code segment that performs an integrity check prior to communicating with a second software module;
a code segment that encrypts data to be communicated to the second software module using the embedded encryption/decryption algorithm and the first encryption key;
a code segment that transmits the encrypted data from the first software module to the second software module; and
a code segment that decrypts the encrypted data at the second software module using an embedded encryption/decryption algorithm and a corresponding second encryption key.

11. The software recited in claim 10 wherein the code segment that performs the integrity check comprises a code segment that sums a binary representation of the executable with the first encryption key.

12. The software recited in claim 10 wherein the code segment that performs the integrity check comprises a code segment that performs a hashing function on a binary representation of the executable with the first encryption key.
